(19) United States
(12) Patent Application Publication
(10) Pub. No.: US 2013/0333287 A1
(43) Pub. Date: Dec. 19, 2013

(54) PLANTER ASSEMBLY

(71) Applicant: Van M. Kassouni, Grand Rapids, MI (US)

(72) Inventor: Van M. Kassouni, Grand Rapids, MI (US)

(21) Appl. No.: 13/912,236

(22) Filed: Jun. 7, 2013

Related U.S. Application Data
(60) Provisional application No. 61/659,118, filed on Jun. 13, 2012.

(51) Int. Cl. A01G 9/02

(52) U.S. Cl. CPC A01G 9/023
USPC 47/83

(57) ABSTRACT

A planter assembly includes a support and a plurality of planter units configured to attach at the support. The support is an elongated support that is configured to be generally vertical when used in the planter assembly. Each of the planter units includes a planting portion at which a plant may be disposed and each of the planter units is configured to attach at the support at a respective level along the support. Each of the planter units is circumferentially disposed relative to the support and relative to others of the planter units so that the planter units are arranged along the support with the planting portion of each of the planter units being at least partially circumferentially separated or disposed relative to the planting portions of others of the planter units.

### CROSS REFERENCE TO RELATED APPLICATION

The present application claims the filing benefit of U.S. provisional application Ser. No. 61/659,118, filed Jun. 13, 2012, which is hereby incorporated herein by reference in its entirety.

### FIELD OF THE INVENTION

The present invention relates generally to planters, more particularly, to planting containers for garden plants and the like.

### BACKGROUND OF THE INVENTION

Vegetation planters are typically round or rectangular shaped individual pots in which plants and soil are placed. Sometimes, the pots or containers are hung from overhead structures or the like.

### SUMMARY OF THE INVENTION

The present invention provides a planter assembly that comprises a plurality of individual planters arranged at a post or support structure so as to provide a helical configuration or spiral staircase effect. The planters may have generally flat or horizontal bottoms and can be arranged in a stepped or staircase configuration about and around the post or support structure, or the planters may have ramped bottoms and can be arranged in a ramped or waterfall configuration about and around the post or support structure.

According to an aspect of the present invention, a planter assembly includes a support and a plurality of planter units. The support comprises an elongated support that is configured to be generally vertical when used in the planter assembly. The plurality of planter units are configured to attach at the support, and each of the planter units comprises a planting portion in which a plant may be planted. Each of the planter units is configured to attach at the support at a respective level along the support, and each of the planter units is circumferentially disposed relative to the support and relative to others of the planter units so that the planter units are arranged along the support with the planting portion of each of the planter units being at least partially circumferentially separated or disposed relative to the planting portions of others of the planter units.

Each of the planter units may comprise a receiving portion that receives the support therethrough to attach the planter units at the support. The receiving portions may stack on top of one another to vertically dispose the planter units along the support. Optionally, and desirably, the support may have a multi-sided cross section, and the receiving portion of each of the planter units may be correspondingly configured to non-rotatably receive the support therein.

Optionally, the planting portions of the planter units may comprise flat bottoms that are generally horizontal when the planter units are attached at the generally vertical support. The planter units may thus be attached at the generally vertical support so that the planting portions of the planter units provide a helical staircase configuration at least partially around the support.

Optionally, the planting portions of at least some of the planter units may comprise ramped bottoms that are generally ramped or non-horizontal when the planter units are attached at the generally vertical support. The plurality of planter units thus may be attached at the generally vertical support so that the planting portions of the planter units provide a helical ramp or waterfall configuration at least partially around the support.

Thus, the present invention provides a planter assembly that has a plurality of individual planter units disposed circumferentially along a generally vertical support and disposed at different heights or levels along the support. The planter units may be attached at least partially circumferentially around the support such that the planting portion of none of the planter units is disposed directly above a planting portion of any other of the planter units. The planter units may be configured to provide a helical staircase configuration or a helical waterfall configuration or any other desired configuration or arrangement of planter units along the generally vertical support, depending on the particular application of the planter assembly.

These and other objects, advantages, purposes and features of the present invention will become more apparent upon review of the following specification in conjunction with the drawings.

### BRIEF DESCRIPTION OF THE DRAWINGS

FIG. 1 is a perspective view of a stepped spiral planter assembly in accordance with the present invention, shown with a plurality of stepped spiral planter units arranged at a post;

FIG. 2 is another perspective view of the stepped spiral planter assembly of FIG. 1;

FIG. 3 is a perspective view of an individual stepped spiral planter unit of the stepped spiral planter assembly of FIGS. 1 and 2;

FIG. 4 is another perspective view of the stepped spiral planter unit of FIG. 3;

FIG. 5 is a side elevation of the stepped spiral planter unit of FIGS. 3 and 4;

FIG. 6 is an opposite side elevation of the stepped spiral planter unit of FIG. 5;

FIG. 7 is another side elevation of the stepped spiral planter unit of FIGS. 3 and 4;

FIG. 8 is an opposite end elevation of the stepped spiral planter unit of FIG. 7;

FIG. 9 is a top plan view of the stepped spiral planter unit of FIGS. 3 and 4;

FIG. 10 is a bottom plan view of the stepped spiral planter unit of FIGS. 3 and 4;

FIG. 11 is a perspective view of a ramped spiral planter assembly in accordance with the present invention, shown with a plurality of ramped spiral planter units and a base stepped spiral planter arranged at a post;

FIG. 12 is another perspective view of the ramped spiral planter assembly of FIG. 11;

FIG. 13 is a perspective view of an individual ramped spiral planter unit of the ramped spiral planter assembly of FIGS. 11 and 12;

FIG. 14 is another perspective view of the ramped spiral planter unit of FIG. 13;

FIG. 15 is a side elevation of the ramped spiral planter unit of FIGS. 13 and 14;

FIG. 16 is an opposite side elevation of the ramped spiral planter unit of FIG. 15;

FIG. 17 is another side elevation of the ramped spiral planter unit of FIGS. 13 and 14;

FIG. 18 is an opposite end elevation of the ramped spiral planter unit of FIG. 17;

FIG. 19 is a top plan view of the ramped spiral planter unit of FIGS. 13 and 14; and

FIG. 20 is a bottom plan view of the ramped spiral planter unit of FIGS. 13 and 14.

### DESCRIPTION OF THE PREFERRED EMBODIMENTS

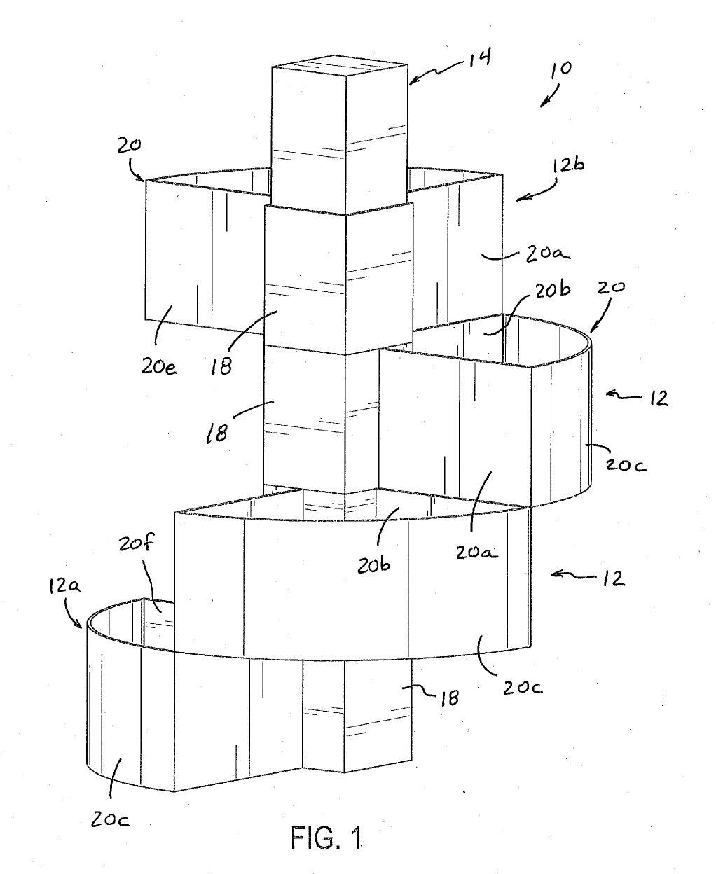

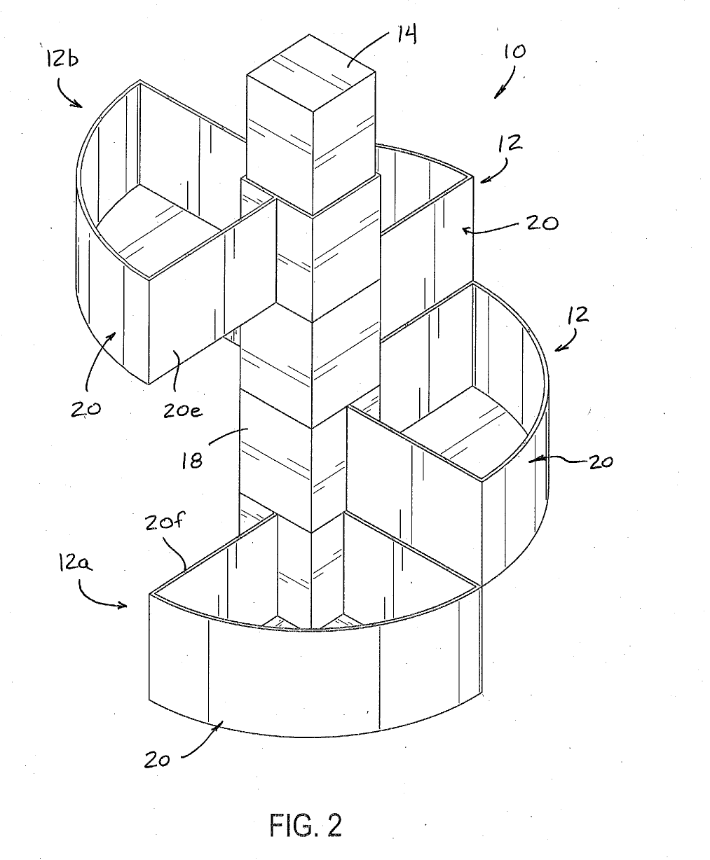

Referring now to the drawings and the illustrative embodiments depicted therein, a planter assembly 10 (FIGS. 1 and 2) provides a plurality of individual planters 12, which may hold or support plants, such as garden plants, small trees, shrubs, and other potable plants and/or the like, and which are arranged in a helical configuration about a central post or generally vertical support 14, so as to provide a spiral staircase arrangement of individual planters about and at least partially around the support 14. The planter units 12 are attached at the generally vertical support 14 and vertically stack on top of one another to vertically dispose or space the planter units along the support. A planting portion 20 of each of the planter units 12 radially extends from an attaching portion 18 of the planter units, and the planter units 12 are attached at the support 14 such that the planting portion 20 of each of the planter units 12 is at least partially vertically and circumferentially separated or disposed relative to the planting portions 20 of others of the planter units 12, when the planter units are attached at the generally vertical support, as discussed below.

The support 14 comprises an elongated support that is configured for use in a generally vertical orientation (such as via insertion of a lower end of the post into the support surface or ground or the like such that the post is disposed in a generally vertical orientation). The support 14 may comprise any suitable elongated support structure, such as a post or rod, and may have any suitable cross section. In the illustrated embodiment, the support 14 has a rectangular cross section having four sides or surfaces. However, it is envisioned that the support may comprise a cross section having any number of sides or surfaces, such as three sides or five or more sides, and may bend or twist to a desired configuration or shape, while remaining within the spirit and scope of the present invention. Optionally, it is envisioned that the support may comprise a generally cylindrical post or rod, and may be bent or formed to a desired configuration or shape. Support 14 may comprise any suitable material, such as plastic or polymeric or metallic material and may be substantially rigid so that its lower end is insertable into the ground. Optionally, the post may be attached to a base structure that supports the support or post in a generally vertical orientation without requiring the post or support to be sunk into the ground. Optionally, the support may comprise a wooden post, such as a 4×4 wooden post (having a cross dimension or width of about 3½ inches or thereabouts) or 6×6 wooden post (having a cross dimension or width of about 5½ inches or thereabouts) that is inserted or anchored into the ground and configured to be received through the attaching portions 18 of the planter units 12.

Each of the planter units 12 comprises the attaching portion 18 and the planting portion 20. Planter units 12 may comprise any suitable material, and may be constructed of a durable plastic or polymeric material (and may be formed by injection molding or the like), or may be constructed of metal or wood, depending on the particular application. The attaching portion 18 of each planter unit 12 is configured to receive support 14 therethrough, and may non-rotatably receive the support therethrough (for embodiments where the support has a non-circular cross section). In the illustrated embodiment, attaching portion 18 has four side walls 18a that define a passageway 18b therethrough for receiving support 14 when the planter unit is attached at the support 14.

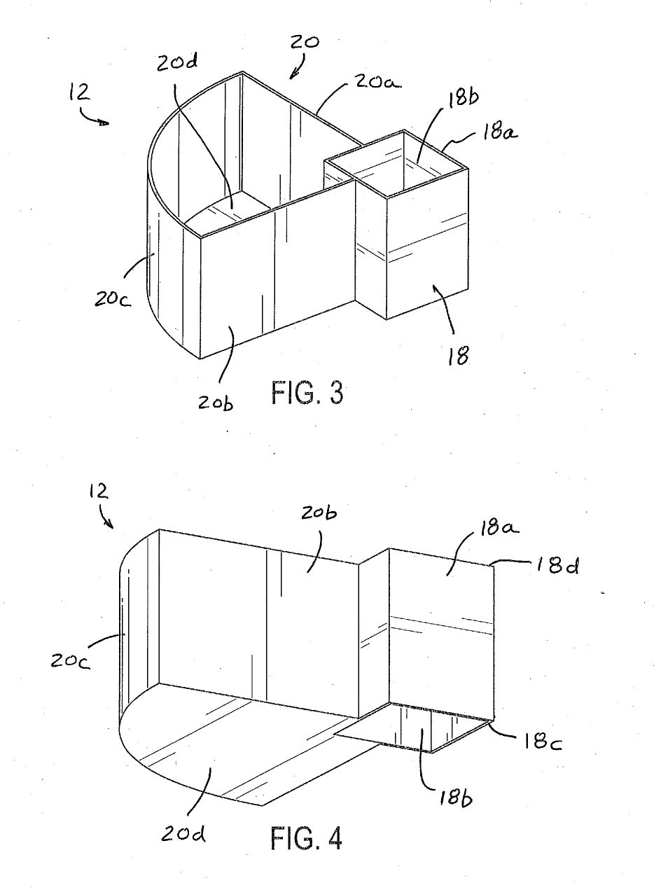

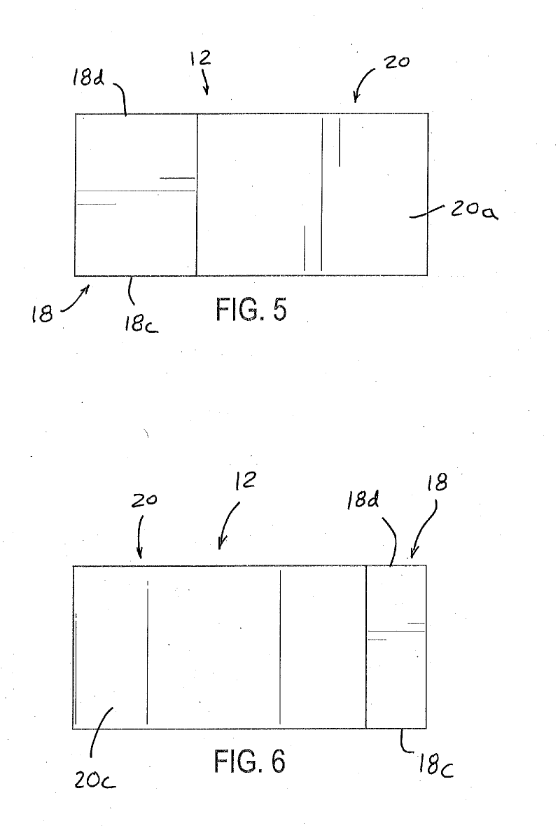

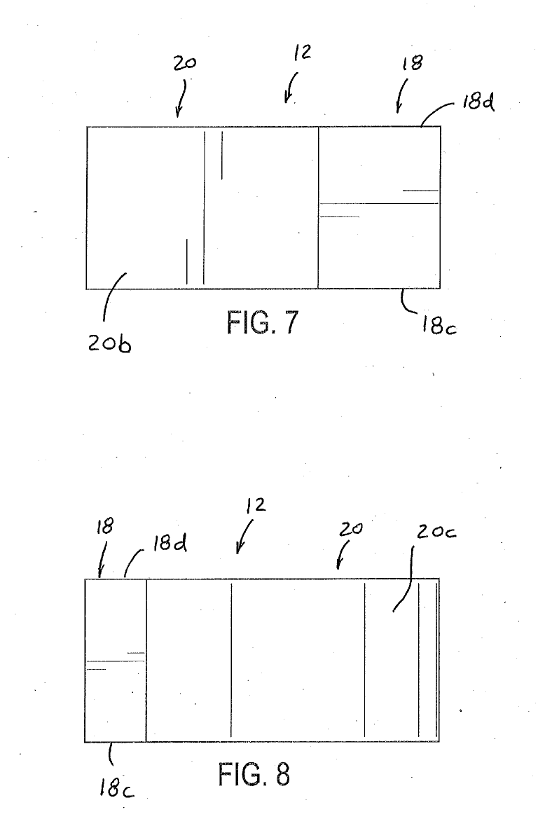

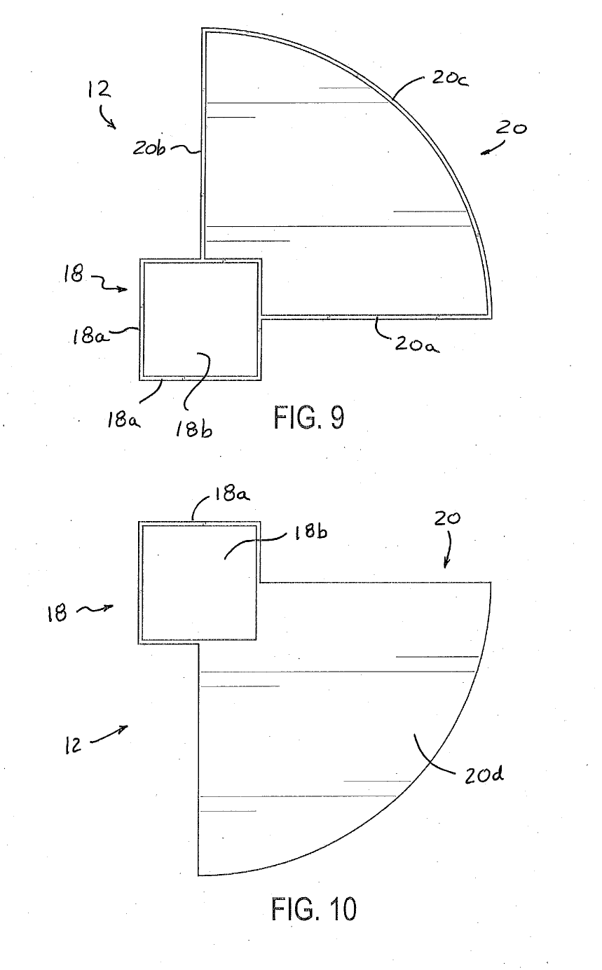

The planting portion 20 of each planter unit 12 extends generally radially outward from the attaching portion 18 and provides a container for holding soil and one or more plants therein. In the illustrated embodiment, the planting portion has side or end walls 20a, 20b that extend radially outwardly from respective side walls 18a of the attaching portion. An arcuate or curved outer surface or wall 20c extends between the outer ends of the end walls 20a, 20b and a bottom surface or wall 20d is disposed at the lower edge regions of end walls 20a, 20b and the outer wall 20c of planting portion 20 and side walls 18a of attaching portion 18. In the illustrated embodiment of FIGS. 1-4, the bottom wall 20d comprises a generally horizontal wall or surface when the planter unit 12 is attached at the generally vertical support 14. The bottom wall 20d may be generally level with a lower end 18c of the attaching portion 18, and an upper edge region of the walls 20a-c and 18a may be generally level with an upper end 18d of attaching portion 18.

Thus, the planter units 12 may be disposed or stacked at the support 14 to provide the desired configuration of the planter portions 20 around or partially around the support 14. As shown in FIGS. 1 and 2, the attaching portions 18 are stacked on top of one another to vertically space or dispose the planter units 12 along the support 14, with each planter unit being circumferentially disposed 90 degrees from the adjacent planter unit such that each planting portion 20 encompasses a different 90 degree arc (or other degree arc depending on the particular application) around the support 14. When four planter units 12 (such as shown in FIGS. 1 and 2) are disposed in such a manner at the four-sided support 14, none of the planting portions 20 is disposed over or is vertically aligned with any of the other planting portions 20, such that each planting portion (and any plants planted therein) may be equally exposed to sunlight and/or rain or water or the like. A base planter unit 12a may be disposed at the bottom or lower end region of the support and may be at or rest on the ground at which the support is disposed. When the other planter units are stacked on top of the base planter unit 12 as shown, an end wall 20e of a top planter unit 12b may be generally aligned with or vertically at or near an end wall 20f of the bottom or base planter unit 12a. Optionally, the planter portion may extend below the lower end of the attaching portion, whereby the lower portion of an end wall of the planter portion of an upper planter unit may oppose an upper portion of an end wall of the planter portion of an adjacent lower planter unit in an overlapping manner.

Thus, the planter assembly 10 provides a helical staircase configuration of the planter units around and along the support 14, with no or minimal overlapping of the planting portions around the support. For example, an end wall of a lower planter unit may be generally aligned with or vertically aligned with an end wall of an upper or adjacent planter unit. Optionally, it is envisioned that the planting portions may span or encompass a larger arc (or smaller arc) and may partially overlap one another (or may be spaced from one another) when stacked at the support. The curved outer walls 20c of the planter units may have a radius of curvature that generally matches the distance from the center of the support to the outer wall, such that the curved outer walls provide a substantially continuous 360 degree or circular profile when viewed from the top or bottom of the planter assembly.

Optionally, it is envisioned that the planter units may be otherwise disposed at the support and not in a staircase manner. For example, a second planter unit may be disposed 180 degrees from the orientation of the first or base planter unit and a third planter unit may be disposed 90 degrees from the orientation of the base planter unit or the like, in order to provide the desired configuration and appearance of the planter assembly. The planter units may be removably attached at the support so as to allow for adjustment of the planter assembly to provide the desired configuration or appearance.

Although shown and described as having a four-sided support and four planter units disposed thereat, it is envisioned that the support may comprise any suitable or desired cross-sectional shape and any suitable or desired planter units may be disposed thereat, depending on the particular application of the planter assembly and the desired appearance and/or effect of the planter assembly. In embodiments or configurations where the post or support may comprise a different cross section (such as a three-sided support or a five-sided or six-sided support or the like), the attaching portions 18 of the planter units are similarly constructed so as to correspond with the cross sectional shape of the support so as to non-rotatably receive the support therethrough when assembling the planter assembly. In such other configurations, the planting portions may sweep or encompass a different sized arc (such as about a 120 degree arc for a three-sided support or a 72 degree arc for a five-sided support or a 60 degree arc for a six-sided support and/or the like) to provide the desired non-overlapping staircase effect.

Optionally, for configurations where the support may comprise a cylindrical rod or post and the attaching portions may also comprise cylindrical passageways, it is envisioned that the planter units may be stacked onto the support in a similar manner as discussed above, and then rotated to provide the desired arrangement (and optionally partially overlapping one another) and then may be secured relative to the post or support, such as via a screw or bolt or fastener driven or inserted through the side wall of the attaching portion and a side wall of the support. Optionally, it is envisioned that the support may comprise a threaded support and the passageway of the attaching portions may be threaded, whereby the planter units may be threadedly disposed along the support. In such an application, the height of the planter units may be selected according to the thread pitch, whereby when an upper planter unit seats on or against a lower planter unit, the upper planter unit is rotated a desired amount relative to the lower planter unit (such as 60 degrees or 90 degrees or the like relative to the lower planter unit).

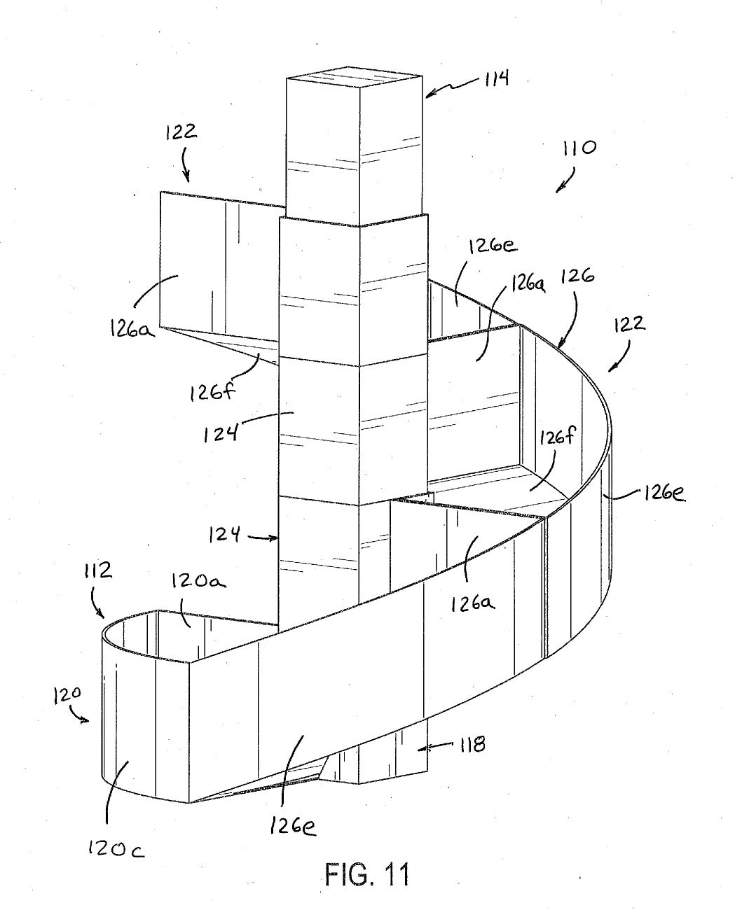

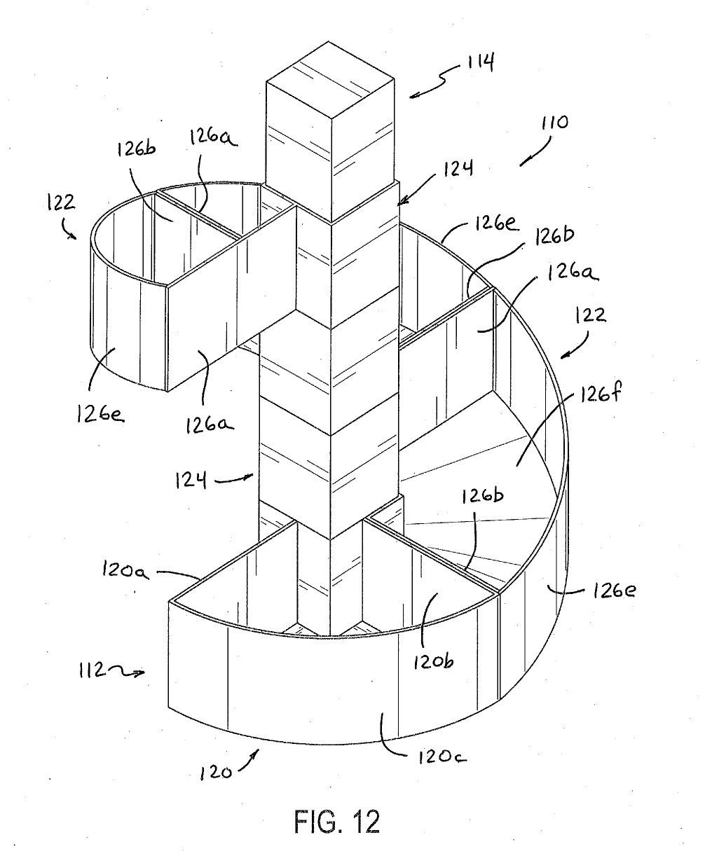

Optionally, other shapes of planter units may be implemented while remaining within the spirit and scope of the present invention. For example, and with reference to FIGS. 11 and 12, a planter assembly 110 includes a base planter unit 112 (such as a planter unit similar in construction planter units 12, discussed above) and a plurality of ramped planter units 122 having attaching portions 124 stacked on top of base planter unit 112 and along an elongated, generally vertical support 114. Planter assembly 110 may be similar in construction and assembly as planter assembly 10, discussed above, but with the planter units having ramped planting portions 126, as discussed below.

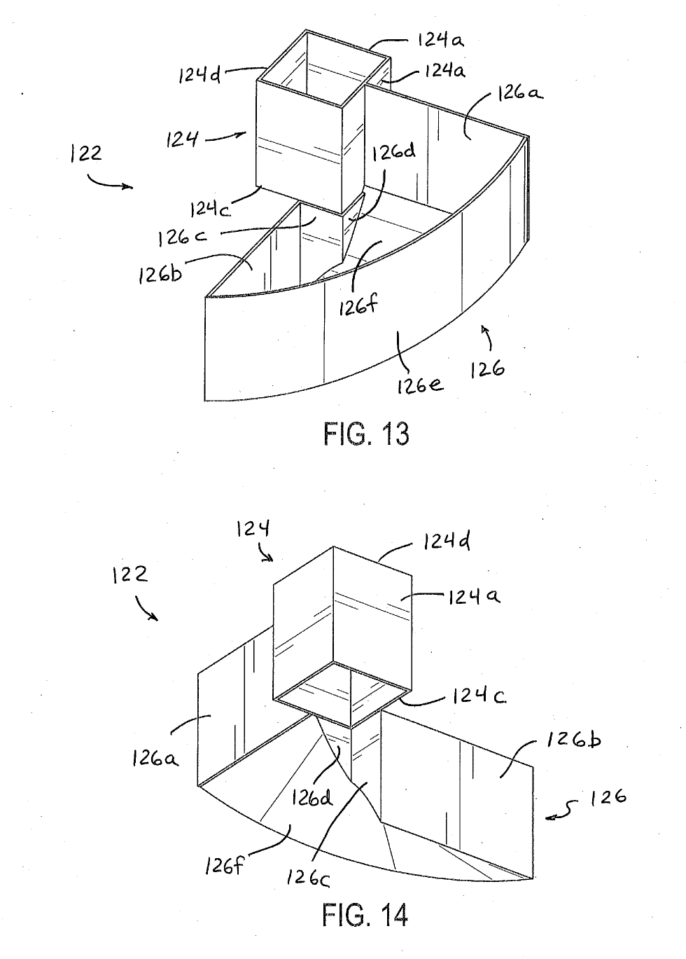

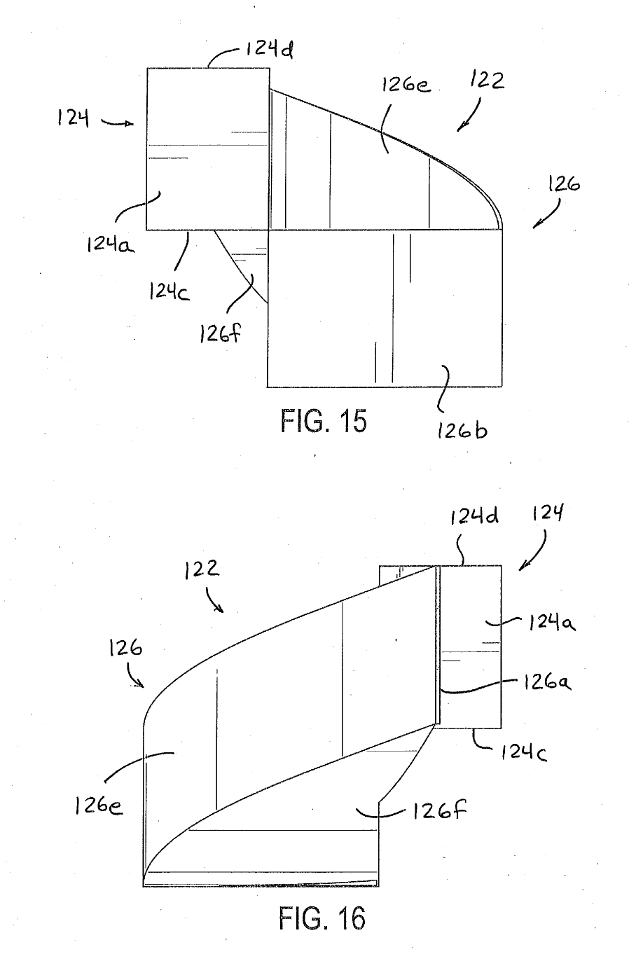

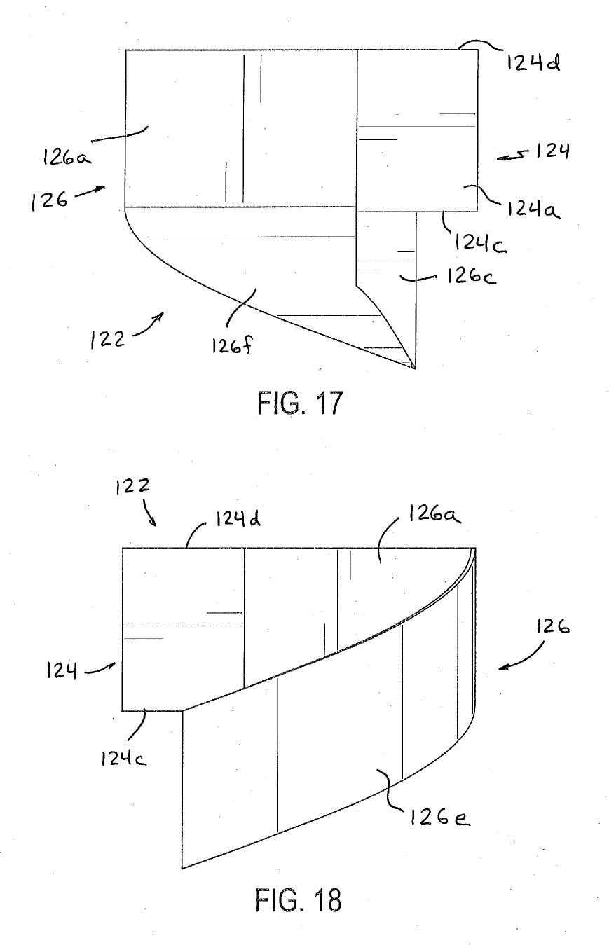

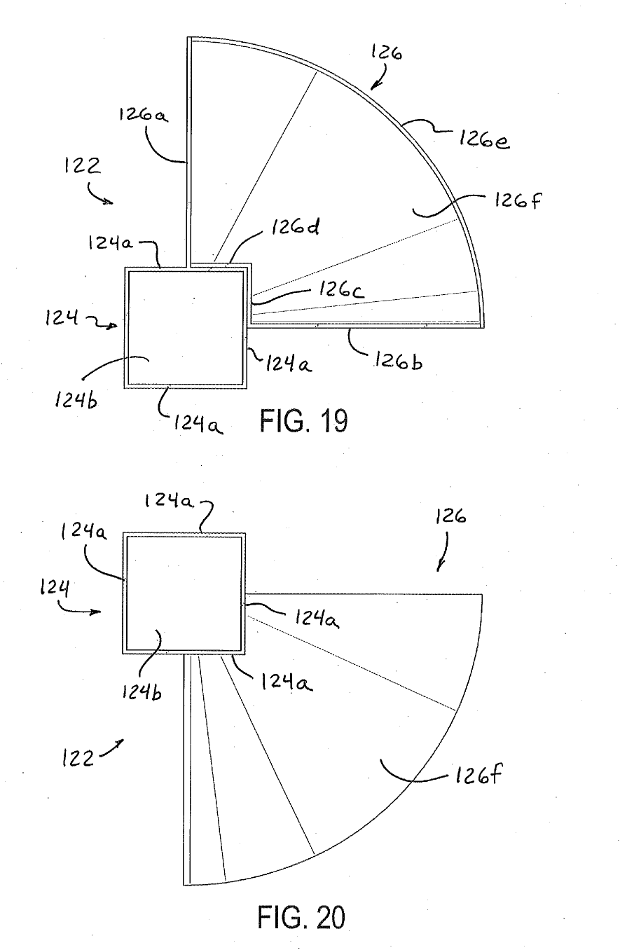

As can be seen with reference to FIGS. 11-20, attaching portions 124 of ramped planter units 122 may be generally similar to attaching portions 20 of planter units 12, discussed above, and may include four side walls 124a defining a passageway 124b therethrough, with a lower end 124c and an upper end 124d. The ramped planting portion 126 has an upper end wall 126a that extends radially from a respective side wall 124a of the attaching portion and a lower end wall 126b that is disposed below the lower end 124c of the attaching portion 124. The lower end wall 126b extends radially outwardly from an inner wall 126c that is generally parallel to but below and radially outboard from a corresponding one of the side walls 124a of attaching portion 124, while inner wall 126c is joined or formed with another inner wall 126d that is generally parallel to but below and radially outboard from a corresponding one of the side walls 124a of attaching portion 124. An arcuate or curved outer surface or wall 126e extends between the outer ends of the end walls 126a, 126b and a ramped or upwardly sloping or curved bottom surface or wall 126f is disposed at the lower edge regions of end walls 126a, 126b, inner walls 126c, 126d and outer curved wall 126e of the planting portion 126 and side walls 124a of the attaching portion 124. The upper edge region of the upper end wall 126a at the upper end of the bottom wall 126f thus may be generally level with the upper end 124d of the attaching portion 124, and the upper edge region of the lower end wall 126b may be generally level with the lower end 124c of attaching portion 124.

Optionally, one or more divider walls or ribs or structures may be disposed along and within the ramped planting portion 126 (such as extending radially inward from the outer curved wall and along the ramped bottom wall) to provide smaller compartments for holding soil or the like, in order to limit the soil from flowing down and collecting at the bottom end of the ramped planting portion 126. The divider walls may attach or extend from inner walls 126c and/or 126d and may function to structurally join the inner wall or walls 126c, 126d with the corresponding walls 124a of the attaching portion, in order to provide enhanced structural rigidity to the inner walls 126c, 126d.

Thus, the ramped planter unit 122 provides a partially helical-shaped planting portion 120 that slopes upwardly around the support 114 when the ramped planter unit 122 is attached at the support 114. As shown in FIGS. 11 and 12, when a ramped planter unit 122 is disposed at and on top of a base or non-ramped planter unit 112, the attaching portion 124 of ramped planter unit 122 may rest on the attaching portion 118 of base planter unit 112, and the lower end wall 126b of ramped planting portion 126 may be disposed at or abut against an end wall 120b of planting portion 120 of base planter unit 112. The ramped planting portion 126 of ramped planter unit 122 slopes upwardly from lower end wall 126b to upper end wall 126a, which is generally at or level with the upper end 124c of attaching portion 124. Because the inner walls 126c, 126d are radially outboard of the attaching portion walls 118a, the inner walls slide over or overlap the attaching portion walls 118 to allow for the attaching portion 124 to rest on the attaching portion 118 of the base planter unit 112, such that the lower end of the ramped planting portion is generally at and generally aligned with the end of the base planter unit 112. Optionally, to provide additional support to the ramped planting portion 126, a fastener may be inserted through or driven through one or both of inner walls 126c, 126d of ramped planting portion 126 and into corresponding walls 118a of attaching portion 118 of base planter unit 112 and optionally into the support 114 (or optionally one or more tabs or attachment features may be formed at the corresponding walls of the planter units to provide additional support at the lower end region of the ramped planting portion).

Similarly, and as also shown in FIGS. 11 and 12, when another ramped planter unit 122 is disposed at and on top of a lower ramped planter unit 112, the attaching portion 124 of the upper ramped planter unit 122 may rest on the attaching portion 124 of the lower ramped planter unit 122, and the lower end wall 126b of ramped planting portion 126 of the upper ramped planter unit may be disposed at or abut against the upper end wall 126b of the planting portion 126 of the lower ramped planter unit. Because the inner walls 126c, 126d are radially outboard of the attaching portion walls 124a, the inner walls 126c, 126d slide over or overlap the attaching portion walls 124a of the attaching portion 124 of the lower ramped planter unit to allow for the attaching portion 124 of the upper ramped planter unit to rest on the attaching portion 124 of the lower ramped planter unit, such that the lower end of the ramped planting portion of the upper ramped planter unit is generally at and generally aligned with the upper end of the ramped planting portion of the lower ramped planter unit. Optionally, to provide additional support to the ramped planting portion 126, a fastener may be inserted through or driven through one or both of inner walls 126c, 126d of ramped planting portion 126 of the upper ramped planter unit and into corresponding walls 124a of attaching portion 124 of the lower ramped planter unit and optionally into the support 114 (or optionally one or more tabs or attachment features may be formed at the corresponding walls of the planter units to provide additional support at the lower end region of the upper ramped planting portion). One or more additional planter units may be disposed at the support in a similar manner.

Any number of planter units may be attached at the support, and may provide about 360 degrees of planting around the support (such that the upper end 126a of the planting portion 126 of the uppermost planter unit 122 may be generally vertically aligned with the first end 120a of the planting portion 120 of the base planter unit 112. Optionally, more planter units may be added such that the uppermost planter unit or units may overlap the base or lower planter unit or units. The curved outer walls 120c and 126e of the planter units may have a radius of curvature that generally matches the distance from the center of the support to the outer wall, such that the curved outer walls provide a substantially continuous 360 degree helical wall that extends from the base unit to the upper end of the uppermost planter unit.

Thus, the planter assembly 110 provides a helical ramp or waterfall configuration of the planter units around and along the support 114, with no or minimal overlapping of the planting portions around the support. For example, an upper end wall of a lower planter unit may be generally aligned with or opposing the lower end wall of an upper or adjacent planter unit. In the illustrated embodiment, each planter unit has a planting portion that spans about a 90 degree arc, but clearly other configurations may be implemented (such as planting portions that span about a 72 degree arc for assemblies with a five-sided support or that span about a 60 degree arc for assemblies with a six-sided support or the like, such as discussed above), while remaining within the spirit and scope of the present invention.

Although shown and described as having formed units that attach at a post and have a planter portion integrally or unitarily formed with the attachment portion, it is envisioned that the planter assembly of the present invention may provide a plurality of pot holders that may attach at a post (such as in a spiral or helical arrangement). The pot holders may comprise metallic rings or support elements, with an attaching ring or portion configured to attach at a post and a pot holding ring or portion that protrudes radially outwardly from the post and is configured to support a pot or planter thereat (such as a conventional round pot or the like that holds dirt/soil and plants). For example, a pot holding portion may comprise a metallic ring that is sized and shaped to partially receive a pot or planter therein (with the pot having a tapered or conical outer wall that engages the metallic ring and limits or precludes the pot from dropping through the ring). A plurality of pots or planters thus may be attached at and supported at a post to provide a desired spiral or helical or stepped arrangement of plants around the post. The attachment portion of the planter rings may comprise any suitable shape for receiving and/or attaching at a post (which may also comprise any suitable shape, such as a square cross section or a circular cross section or the like). The pot holding portion or ring may also comprise any suitable shape, such as a round or circular shape or a square or rectangular shape or a triangular shape or any other shape for receiving and/or supporting a selected planter or pot thereat. The planter supports may comprise any suitable material, such as a metallic material or plastic or polymeric material, and may be sized and shaped to configure to or adapt to any suitable post or vertical support and/or to any suitable pot or planter.

Therefore, the present invention provides a plant support structure or planter assembly that is readily configurable to a desired step configuration or waterfall configuration or the like. The planter assembly provides a plurality of planting portions circumferentially disposed around and along a generally vertical support, and each of the planting portions may be non-overlapping with any of the other planting portions so that each planting portion is substantially exposed to sunlight and rainfall (without any of the other planting portions directly obstructing or blocking sun/rain from the planting portion or portions below).

Changes and modifications to the specifically described embodiments may be carried out without departing from the principles of the present invention, which is intended to be limited only by the scope of the appended claims as interpreted according to the principles of patent law including the doctrine of equivalents.

The embodiments of the invention in which an exclusive property is claimed are defined as follows:

1. A planter assembly comprising:
a support, wherein said support comprises an elongated support that is configured to be generally vertical when used in said planter assembly;
a plurality of planter units configured to attach at said support, wherein each of said planter units comprises a planting portion at which a plant may be disposed; and
wherein each of said planter units is configured to be disposed at a respective level along said support, and wherein said planting portion of each of said planter units is circumferentially disposed relative to said planting portions of others of said planter units so that said planter units are arranged along said support with said planting portions of said planter units being at least partially circumferentially separated or disposed relative to said planting portions of others of said planter units.

2. The planter assembly of claim 1, wherein said planter units are circumferentially disposed 90 degrees relative to one another.

3. The planter assembly of claim 2, wherein said plurality of planter units comprises four planter units and wherein said planter units are arranged at 90 degree intervals around said support.

4. The planter assembly of claim 1, wherein said planting portions of said plurality of planter units comprise flat bottoms that are generally horizontal when said plurality of planter units are attached at said generally vertical support.

5. The planter assembly of claim 4, wherein said plurality of planter units are attached at said generally vertical support so that said planting portions of said planter units provide a helical staircase configuration at least partially around said support.

6. The planter assembly of claim 4, wherein said plurality of planter units includes a base planter unit that is disposed generally at or near the ground when said support is disposed at the ground.

7. The planter assembly of claim 1, wherein said planting portions of at least some of said plurality of planter units comprise ramped bottoms that are generally ramped or non-horizontal when said at least some of said plurality of planter units are attached at said generally vertical support.

8. The planter assembly of claim 7, wherein said at least some of said plurality of planter units are attached at said generally vertical support so that said planting portions of said planter units provide a helical ramp or waterfall configuration at least partially around said support.

9. The planter assembly of claim 7, wherein said planting portion of a base one of said plurality of planter units comprises a flat bottom that is generally horizontal when said base is attached at said generally vertical support.

10. The planter assembly of claim 1, wherein each of said planter units comprises a receiving portion that receives said support therethrough to dispose said planter units at said support.

11. The planter assembly of claim 10, wherein said receiving portions of said planter units stack on top of one another to vertically dispose said planter units along said support.

12. The planter assembly of claim 11, wherein said support has a multi-sided cross section, and wherein said receiving portion of each of said planter units is configured to non-rotatably receive said support therein.

13. The planter assembly of claim 12, wherein said support has a rectangular cross section and wherein said plurality of planter units comprises four planter units and wherein said planter units are arranged at 90 degree intervals around said support such that said planting portions of each of said planter units encompasses about a 90 degree arc around said support.

14. The planter assembly of claim 1, wherein said planter units are attached at least partially circumferentially around said support such that said planting portion of none of said plurality of planter units is disposed directly above said planting portion of any other of said plurality of planter units.

15. The planter assembly of claim 14, wherein an end of an uppermost one of said planter units is generally vertically aligned with an end of a base one of said planter units.

16. The planter assembly of claim 1, wherein an upper end wall of a lower planter unit is generally aligned with a lower end wall of an upper planter unit.

17. The planter assembly of claim 1, wherein an upper end wall of a lower planter unit is generally vertically aligned with a lower end wall of an upper planter unit.

18. The planter assembly of claim 1, wherein said planting portion of each of said planter units is configured to support a pot thereat.

19. A planter assembly comprising:
an elongated support;
a plurality of planter units configured to be disposed along said elongated support, wherein each of said planter units comprises an attaching portion for attaching said planter unit at said elongated support and a planting portion at which a plant may be disposed; and
wherein said attaching portions are configured to receive said support therethrough to dispose said planter units at said support, wherein said receiving portions of said planter units stack on top of one another to vertically dispose said planter units along said support;
wherein said planting portion of each of said planter units is circumferentially disposed relative to said support and relative to planting portions of others of said planter units so that said planter units are arranged along said support with said planting portions of said planter units being at least partially circumferentially separated or disposed relative to said planting portions of others of said planter units.

20. The planter assembly of claim 19, wherein said planting portions of said plurality of planter units comprise flat bottoms that are generally horizontal when said plurality of planter units are attached at said generally vertical support, and wherein said plurality of planter units are attached at said generally vertical support so that said planting portions of said planter units provide a helical staircase configuration at least partially around said support.

21. The planter assembly of claim 19, wherein said planting portions of at least some of said plurality of planter units comprise ramped bottoms that are generally ramped or non-horizontal when said at least some of said plurality of planter units are attached at said generally vertical support, and wherein said at least some of said plurality of planter units are disposed at said generally vertical support so that said planting portions of said planter units provide a helical ramp or waterfall configuration at least partially around said support.
